(19) United States
(12) Patent Application Publication
(10) Pub. No.: US 2021/0079717 A1
(43) Pub. Date: Mar. 18, 2021

(54) THRESHOLD AND THRESHOLD CAP

(71) Applicant: Endura Products, LLC, Colfax, NC (US)

(72) Inventors: Michael K. Mitchell, Winston-Salem, NC (US); Tomasz Jaskiewicz, Oak Ridge, NC (US); Adam Kendall, Burlington, NC (US)

(73) Assignee: Endura Products, LLC, Colfax, NC (US)

(21) Appl. No.: 17/109,309

(22) Filed: Dec. 2, 2020

Related U.S. Application Data
(63) Continuation of application No. 15/962,410, filed on Apr. 25, 2018, now Pat. No. 10,858,881.

(51) Int. Cl. E06B 7/18; E06B 7/23

(52) U.S. Cl. CPC E06B 7/18; E06B 7/2316; E06B 7/2312

(57) ABSTRACT

A threshold has a substrate, a sill deck, an upstanding nosing, and an upstanding dam. An upwardly open sill channel is defined between the upstanding nosing and the upstanding dam. A threshold cap extends along and at least partially overlies the upwardly open sill channel. At least one holder is formed separate from the threshold cap and is located in the upwardly open sill channel between the upstanding dam and the upstanding nosing, the at least one holder at least partially supporting the threshold cap. The holder is removably disposed within the sill channel. The threshold cap is pivotably attached to the holder. The threshold cap is capable of rotating between a raised position and a lowered position. In at least the raised position, a highest point of the threshold cap is closer to the upstanding dam than the upstanding nosing.

### CROSS-REFERENCE TO RELATED APPLICATION

This application is a continuation of U.S. patent application Ser. No. 15/962,410, filed Apr. 25, 2018, the entire contents of which are hereby incorporated by reference.

### FIELD OF DISCLOSURE

The present disclosure relates generally to thresholds for residential and commercial buildings. Many embodiments of the present disclosure relate to thresholds having threshold caps that are self-adjusting.

### BACKGROUND

Entryways provide the necessary ingress and egress from residential and commercial buildings. Entryway systems used in building construction generally include a pair of vertically extending door jambs and a head jamb that frame the entryway and receive at least one hinged door panel. An elongated threshold is generally attached at its ends to the bottoms of the door jambs, and spans the bottom of the entryway. Many modern thresholds include a threshold cap positioned to underlie a closed door mounted in the entryway. In some instances, the threshold cap is manually adjustable in a vertical direction to engage and form a seal with the bottom of the door panel or a flexible sweep attached thereto. Manually adjustable threshold caps remain stationary as the door opens and closes.

Manufacturers of entryway systems and components thereof, continue to seek designs that provide a durable, weather-tight seal. The goal of these components is to function as a system to prevent the unwanted infiltration of air or water through the entryway when the door panel is closed. One known problem is that houses can settle after construction, thus compromising the weather sealing of the door panel due to movement of the mating components from their initial installed position. In the past, a homeowner could vertically adjust the threshold cap manually in order to correct this issue. Experience has shown, however, that homeowners rarely use the adjustment features of the prior art. Accordingly, a need continues to exist for a threshold that improves the ability to seal out air and water along the bottom of the door panel even as the fit between a door panel and the threshold changes.

### SUMMARY

One embodiment of the present disclosure includes an assembly for forming a seal with a door panel. The assembly comprises a holder comprising at least one knuckle for at least partially forming a barrel, the barrel having a longitudinal axis, and a threshold cap configured to underlay the door panel when the door panel is in a closed position. The threshold cap comprises a first wall having a top surface and a bottom surface and a connection arm extending from the bottom surface. The connection arm terminates in a tip having a substantially circular profile. The tip is received in the barrel such that the threshold cap is capable of pivoting relative to the holder about the longitudinal axis.

Another embodiment of the present disclosure includes a threshold for installation in an entryway. The threshold comprises a substrate, a sill deck mounted to the substrate, an upstanding nosing extending along an interior portion of the substrate, and an upstanding dam extending along an inward end of the sill deck. An upwardly open sill channel is defined between the upstanding nosing and the upstanding dam. The upwardly open sill channel is positioned to at least partially underlie a door panel when the door panel is in a closed position. A threshold cap extends along and at least partially overlies the upwardly open sill channel. At least one holder formed separate from the threshold cap is located in the upwardly open sill channel between the upstanding dam and the upstanding nosing. The at least one holder at least partially supports the threshold cap. The holder is removably disposed within the sill channel. The threshold cap is pivotably attached to the holder. The threshold cap is capable of rotating between a raised position and a lowered position. In at least the raised position, a highest point of the threshold cap is closer to the upstanding dam than the upstanding nosing.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

FIG. 1 is a schematic view of an entryway that may benefit from the threshold disclosed herein.

FIG. 2 is a perspective view of a threshold according to an embodiment of the present disclosure.

FIG. 3 is a perspective view of a cap holder according to an embodiment of the present disclosure.

FIG. 4 is a profile view of a threshold cap according to an embodiment of the present disclosure.

FIG. 5 is an end view of the threshold in a raised, door open position.

FIG. 6 is an end view of the threshold in a lowered, door closed position.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

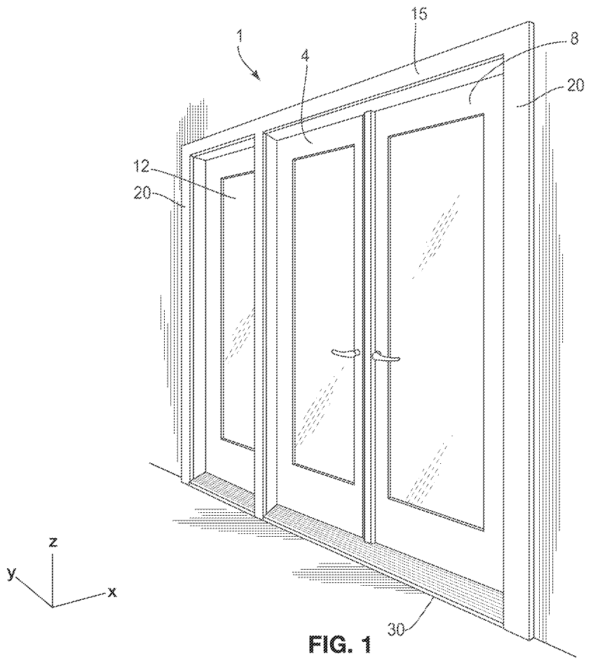

FIG. 1 illustrates an entryway 1 that may incorporate one or more components of the present disclosure. The illustrated entryway 1 includes a French door arrangement with a first door panel 4 and a second door panel 8. The entryway 1 is also shown with a sidelight 12. The top of the entryway 1 includes a header 15, and the edges of the entryway 1 can be defined by side jambs 20. A threshold 30 extends along the bottom of the entryway 1. The configuration of the entryway 1 shown in FIG. 1 is provided as an example only and is not intended to limit the scope of this disclosure. Particularly, the entryway 1 may include only a single door panel, a double door entryway, or even a larger plurality of door panels and windows.

The illustrated embodiments of the present disclosure apply primarily to in-swing type entryways where the door panel is within the interior of the building when the door panel is open. However, unless expressly noted, the type of entryway, e.g., in-swing or out-swing, should not affect the scope of this disclosure. As used herein, the terms interior, inner, inward, etc., and the terms exterior, outer, outward, etc., are used to describe relative positions of features with respect to the entryway 1, the threshold 30, and the inside and outside of a corresponding building when the threshold is in-use. Notably, FIG. 1 illustrates the exterior of the entryway 1. Also, as used herein, the width direction extends from an interior to an exterior of a building, or vice versa. The width direction is defined along the X-axis shown in FIG. 1. The length direction extends relatively between the side jambs 20 of the entryway 1 parallel with the Y-axis shown in FIG. 1. The height direction extends substantially along the vertical direction and parallel with the major axis of the side jambs 20, parallel to the Z-axis in FIG. 1. As used herein, the terms “rigid” and “resilient” are used with respect to one another. Therefore, when an element made from rigid material interacts with an element made from a resilient material, the resilient element will deform more readily than the rigid element. As used herein, rigid materials are intended to maintain their shape and resilient materials are intended to be pliable to alter their shape when faced with anticipated external forces.

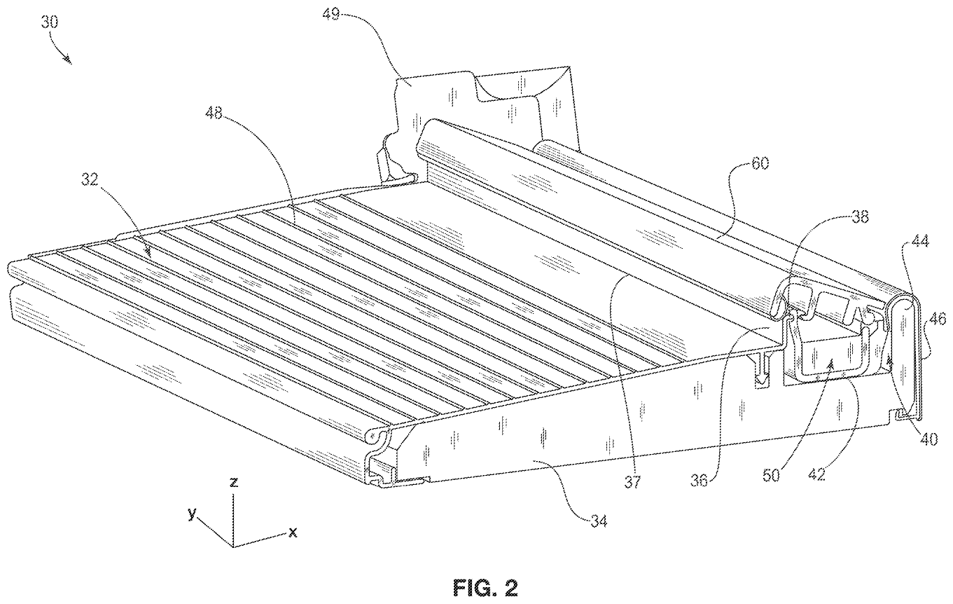

FIG. 2 shows a portion of an assembled threshold 30 according to an embodiment of the present disclosure from an exterior perspective view. As shown, the threshold 30 may include a sill deck 32 disposed upon a substrate 34. A dam 36 may extend upwardly from an inward end 37 of the sill deck 32. In some embodiments, the dam 36 may be formed as part of the sill deck 32. In other embodiments, the dam 36 may be formed separate from the sill deck 32. The dam 36 may include a lip 38 at the top thereof. The lip 38 may extend substantially horizontally in an inward direction. Interior of the dam 36, a sill channel 40 may be formed. The sill channel 40 can be described as upwardly open. The sill channel 40 may have an exterior wall formed at least partially by the dam 36. The sill channel 40 can have a lower surface provided by a floor 42, which may be at least partially defined by the substrate 34. An interior wall, which can be formed at least partially by a nosing 44, can provide the third wall of the sill channel 40. The nosing 44 may be formed as an integral part of the substrate 34 as shown, or the nosing 44 may be separately attached to the substrate 34. In several embodiments, a decorative nosing cover 46 may be provided over and around the nosing 44. The sill deck 32 may provide a tread surface 48 along a portion outward of the dam 36. The threshold 30 may be sealed to the jambs 20 (FIG. 1) using gaskets 49. Example gaskets that may be suitable for use with the threshold of the present disclosure are described in U.S. Pat. No. 9,624,716 to Mitchell.

The threshold 30 of FIG. 2 may also include one or more holders 50 positioned within the sill channel 40 to support and retain a threshold cap 60. In some embodiments, the holders 50 are substantially entirely within the sill channel 40. In some embodiments, not shown, the holder 50 may be integral with the substrate 34 or integral with the sill deck 32. In the illustrated embodiment, the holder 50 is removably disposed within the sill channel 40. Configuring the holder 50 to be removable from the sill channel 40 may be advantageous for manufacturing and assembly purposes, such as creating interchangeability of component parts to provide multiple products with fewer unique components. In an embodiment, a plurality of holders 50 are used to support the threshold cap 60, the holders 50 being spaced apart along a length of the sill channel 40.

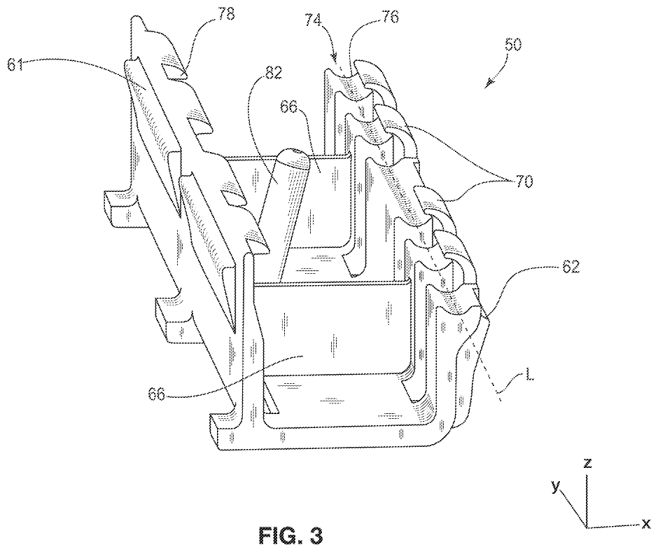

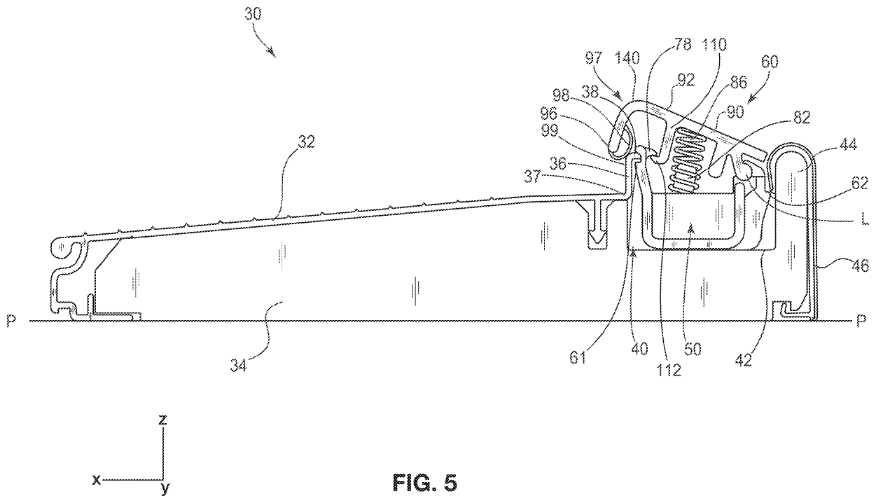

FIG. 3 shows a detailed perspective view of a holder 50 according to one embodiment of the present disclosure. The holder 50 may be designed to have a width (along the x-axis) configured to substantially fill the width of the sill channel 40 (FIG. 2). In one embodiment, during assembly of the threshold 30, the holder 50 may be able to slide along the length of the sill channel 40. The holder 50 may be configured to be retained in the sill channel 40 along a vertical direction (z-axis) through an interference fit. For example, the holder 50 of the illustrated embodiment includes one or more outer retention projections 61 and one or more inner retention projections 62 configured to engage with the lip 38 of the dam 36 and the nosing cover 46 respectively, to retain the holder within the sill channel 40 as shown in FIG. 5.

The holder 50 may be formed from plastic, such as polypropylene. The holder 50 may be formed from processes such as injection molding or additive manufacturing. Depending upon the materials used and the process selected for manufacturing, the holder 50 may include stiffening elements, such as braces 66.

One function of the holders 50 is to support the threshold cap 60 (FIG. 2) with respect to the sill channel 40. Consistent with this function, the holders 50 may be configured to retain the threshold cap 60 and control a range of motion of the threshold cap. To provide retention, the holder 50 may be provided with a plurality of knuckles 70, which are configured to at least partially define a barrel 74. In but one example, seats 76 are arranged in a staggered manner with the knuckles 70 to further define the barrel 74. The barrel 74 has a longitudinal axis L configured to extend along the length (y-axis) of the threshold 30 and define the axis about which the threshold cap 60 may be able to pivot.

To control the range of motion of the threshold cap 60, the holder 50 may be formed with a catch 78 configured to provide an abutment surface for engaging a portion of the threshold cap 60 and limiting upward movement of the threshold cap as discussed further below.

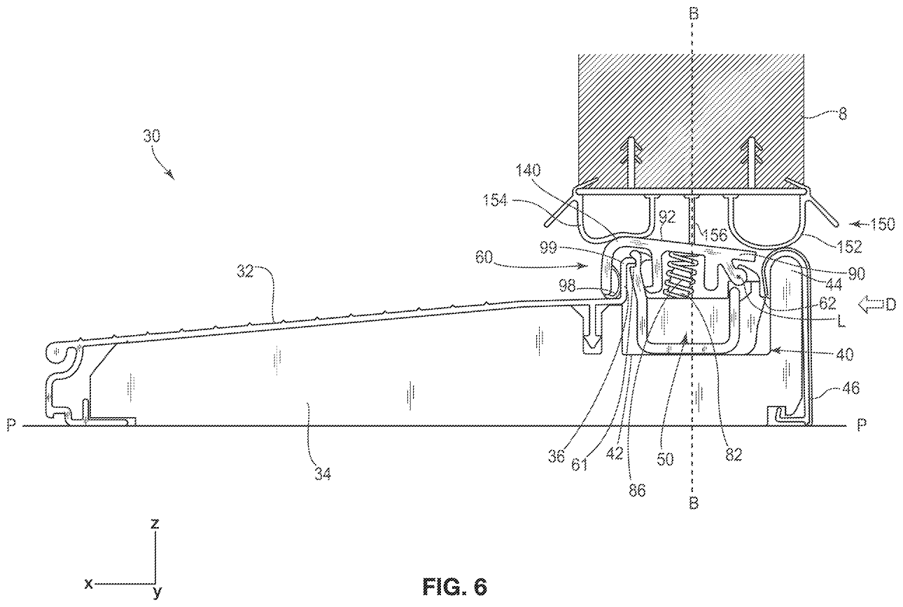

The holder 50 may also include a post 82. The post 82 may be configured to extend along a vertical direction (the z-axis) or may be provided at a pre-determined angle relative to vertical. For example, the post 82 may be configured to be substantially normal to a top wall of the threshold cap 60 in at least one position of the threshold cap. As shown in FIGS. 5 and 6, the post 82 may be configured to support a coil spring 86 between the holder 50 and the threshold cap 60. The spring 86 may be included to provide a force intending to bias the threshold cap 60 toward a raised position thereof (FIG. 5), both when a corresponding door panel is open and when the corresponding door panel is closed. The present disclosure is not limited to biasing the threshold cap 60 with a coil spring 86, but may alternatively include other resilient members formed from resilient materials capable of providing a spring force, such as a leaf spring, or elastic memory materials such as rubber, foam, or Hytrel® that are capable of acting to provide a force which acts to move the threshold cap toward the raised position when the elastic material is deformed. The spring 86 or other resilient member used for biasing the threshold cap 60 may be relatively separate from the threshold cap 60 and the base 50 as shown in the presently illustrated embodiment. Alternatively, the resilient member may be integrated with the holder 50 or integrated with the threshold cap 60.

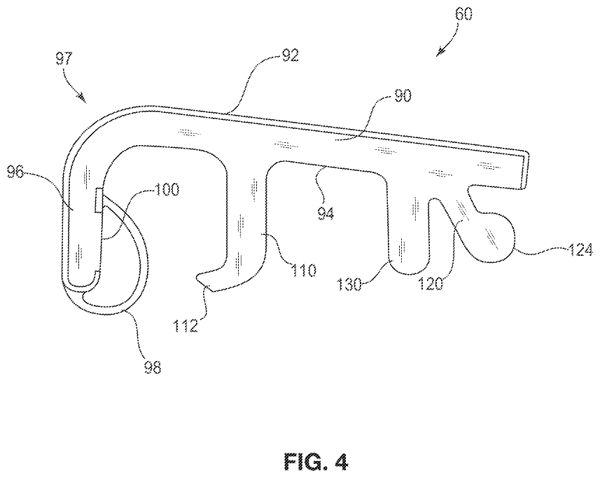

FIG.4 provides a detailed profile view of the threshold cap 60 according to one embodiment of the present disclosure. The threshold cap 60 includes a first wall 90 having a top surface 92 and a bottom surface 94. The top surface 92 of the first wall 90 is configured to provide a sealing surface when a door panel is in the closed position. A second wall 96 may extend from an exterior end 97 of the first wall. The second wall 96 may extend substantially perpendicularly from the bottom surface 94 of the first wall 90 at the exterior end 97 thereof. The second wall 96 may be configured to be positioned along an exterior side 99 of the dam 36 as shown in FIGS. 5 and 6. A seal 98 may be attached at least partially to an interior surface 100 of the second wall 96. The seal 98 is configured to limit intrusion of water between an interior surface 100 of the second wall 96 and the exterior side 99 of the dam 36. The seal 98 may be a resilient bulb. The seal 98 may be co-extruded with the remainder of the threshold cap 60. Alternatively, the seal 98 may be joined to the second wall 96 by other attachments. In other embodiments, the seal 98 may be attached to the dam 36 instead of being movable with the second wall 96.

As shown in FIG. 4, the threshold cap 60 may further comprise a stop arm 110 extending from the bottom surface 94 of the first wall 90. The distal end of the stop arm 110 may include a tab 112 providing an abutment surface to facilitate limiting the range of motion of the threshold cap 60 as discussed in further detail below.

As shown in FIG. 4, the threshold cap 60 further comprises a connection arm 120. The distal end of the connection arm 120 may be formed with a tip 124 having substantially circular profile. The tip 124 is configured for insertion into the barrel 74 created by the holder 50 (FIG. 3), wherein the tip may be able to function as a pin of a hinge as the threshold cap 60 is able to pivot relative to the holder 50.

FIG. 4 also shows an optional rib 130 extending from the bottom surface 94 of the first wall 90. The optional rib 130 may add to the rigidity of the first wall 90. The rib 130 may also assist with the desired positioning of the spring 86 as shown in FIG. 5.

The first wall 90, second wall 96, stop arm 110, connection arm 120, and optional rib 130 may all be integrally formed with one another, for example by a polymer or metal extrusion process that creates the threshold cap 60 with a substantially constant profile along the length thereof. When cooled or otherwise cured, the first wall 90, second wall 96, stop arm 110, connection arm 120, and optional rib 130 may be formed from a material, such as PVC or aluminum, to produce a substantially rigid body. Thus, the threshold cap 60 is configured to rotate about the longitudinal axis L (FIG. 3) without significant bending or flexing of the threshold cap 60 itself.

FIG. 5 shows the threshold 30 with the threshold cap 60 in an upwardmost position. As shown, the threshold cap 60 may be constantly biased toward the upwardmost position by the spring 86 or other resilient member in the illustrated embodiment. The threshold cap 60 may assume the upwardmost position when a corresponding door panel (e.g., door 8 in FIG. 1) is in the opening position. In the upwardmost position, the catch 78 may engage the tab 112 of the stop arm 110 to limit the upward rotation of the threshold cap 60.

The upwardmost position may be configured to locate the highest point 140 of the top surface 92 of the first wall 90 about ¼ inches above the top of the dam 36.

As described above, the second wall 96 is configured to be positioned along an exterior side 99 of the dam 36. The pivot axis L of the threshold cap 60 is positioned substantially adjacent to the nosing 44. As a result, the exterior end 97 of the first wall 90 may define the portion of the threshold cap 60 farthest from the pivot axis L, and therefore the portion which may adjust by the greatest magnitude along a vertical direction. The exterior end 97 may also define a point that achieves the highest position relative to a reference plane P, which may be defined by the bottom of the substrate 34.

FIG. 6 shows a door panel 8 in a closed position. A bottom surface of the door panel 8 may carry a door sweep 150 for forming a seal with the first surface 90 of the threshold cap 60. One suitable door sweep 150 may include an interior bulb 152, an exterior bulb 154, and an intermediate fin 156, each formed of a resilient material and configured to form a seal with the top surface 92 of the rigid first wall 90 of the threshold cap 60. While pliable, the resilient portions of the door sweep 150 are configured to provide sufficient force on the first wall 90 of the threshold cap 60 to oppose the biasing force provided by the spring 86 and cause the threshold cap to pivotably deflect downward away from the upwardmost position shown in FIG. 5 to a lowered position as shown in FIG. 6.

Again, the threshold 30 of the illustrated example may be preferably used with an in-swing door. Therefore, to close the door panel 8 to the position shown in FIG. 6, the door panel travels in the direction of arrow D in FIG. 6. The threshold cap 60, with the exterior end 97 of the first wall 90 capable of providing the highest point 140 of the threshold cap above the reference plane P, creates the primary sealing location. The primary sealing location may have the greatest pressing force between the first wall 90 and one of the resilient portions of the door sweep 150. The primary sealing location is at a position closer to the dam 36 than the nosing 44. The threshold cap 60 is arranged such that the primary sealing location is directly under the door panel 8. Due to the pivoting direction of the threshold cap 60, the primary sealing location is positioned exterior of a bisector B normal to the bottom of the door panel 8. To avoid water penetration across the threshold 30, forming the primary sealing location as far toward the exterior of the building as possible is desired, particularly if that seal is a dynamic seal formed by at least one element subject to an upward biasing force.

In addition, when the threshold cap 60 is raised to its upwardmost position as shown in FIG. 5, the first wall 90 ramps upward toward the exterior of the threshold 30. The act of closing the door panel 8 from the interior along direction D (FIG. 6) provides an initial depression force at a relatively lower, interior portion of the first wall 90, therefore reducing resistance and friction between the door sweep 150 and the threshold cap 60 compared to self-articulating threshold caps having their highest portions positioned toward an interior of the building relative to the bisector B of the door panel.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed:

1. An assembly for forming a seal with a door panel, the assembly comprising:
a nosing defining an interior side of the assembly when installed;
a holder comprising a knuckle that forms at least a partial barrel about a longitudinal axis; and
a threshold cap configured to underlay the door panel when the door panel is in a closed position, the threshold cap comprising:
a first wall having a planar top surface and a planar bottom surface opposite the top surface, the top surface facing a bottom of the door panel in the closed position of the door panel, and
a connection arm extending from the bottom surface towards the nosing, the connection arm terminating in a tip having a substantially circular profile, the tip received in the barrel of the holder such that the threshold cap pivots relative to the holder about the longitudinal axis.

2. The assembly according to claim 1, wherein the threshold cap comprises a second wall extending from an exterior end of the first wall, the second wall extending substantially perpendicularly from the first wall, the second wall configured to be positioned along an exterior side of a dam of a threshold.

3. The assembly according to claim 2, wherein the second wall further comprises at least one resilient seal configured to seal with the exterior side of the dam.

4. The assembly according to claim 1, further comprising a resilient member positioned between the holder and the first wall of the threshold cap to bias the threshold cap toward a raised position.

5. The assembly according to claim 4, wherein the holder comprises a post, and the spring is a coil spring disposed around the post.

6. The assembly according to claim 1, wherein the threshold cap further comprises a stop arm, and the holder further comprises a catch, wherein the stop arm engages the catch when the threshold cap pivots to an upwardmost position of the threshold cap.

7. A threshold, comprising:
a sill deck having a dam extending upwardly therefrom;
a sill channel provided along an interior side of the dam; and
an assembly of claim 1 removably disposed at least partially within the sill channel.

8. The threshold according to claim 7, wherein relative to the door panel in the closed position, the longitudinal axis is located interior of a plane normal to and bisecting a bottom of the door panel.

9. The threshold according to claim 7, wherein the threshold cap is capable of pivoting between a raised position and a lowered position, wherein in the raised position the first wall is sloped upward along a direction toward the dam from an interior of the threshold.

10. The threshold according to claim 7, wherein the holder further comprises at least one interior retention projection and at least one exterior retention projection for retaining the holder within the sill channel.

11. A threshold for installation in an entryway, the threshold having an exterior side and an interior side opposite the exterior side when installed, the threshold comprising:
a substrate;
a sill deck mounted to the substrate;
an upstanding nosing extending along an interior side of the substrate;
an upstanding dam extending adjacent an interior side of the sill deck;
an upwardly open sill channel defined between the upstanding nosing and the upstanding dam, the upwardly open sill channel being positioned to at least partially underlie a door panel when the door panel is in a closed position;
a holder removeably disposed within the sill channel; and
a threshold cap extending along and at least partially overlying the upwardly open sill channel, the threshold cap formed separate from and at least partially supported by the holder, a portion of the threshold cap pivotably received within the holder such that the threshold cap pivots about the portion relative to the holder between a raised position and a lowered position, a highest point of the threshold cap being closer to the upstanding dam than the upstanding nosing in the raised position of the threshold cap.

12. The threshold according to claim 11, wherein the threshold cap is biased toward the raised position when the door panel.

13. The threshold according to claim 12, further comprising a resilient member positioned between the holder and the threshold cap, the resilient member biasing the threshold cap toward a raised position.

14. The threshold according to claim 13, wherein the holder further comprises a post, the resilient member being a coil spring disposed around the post.

15. The threshold according to claim 11, wherein the holder comprises at least one knuckle for at least partially forming a barrel having a longitudinal axis; and the threshold cap comprises:
a first wall having a top surface and a bottom surface, and
a connection arm extending from the bottom surface, the connection arm terminating in a tip having a substantially circular profile, wherein the tip is received in the barrel such that the threshold cap is capable of pivoting relative to the holder about the longitudinal axis.

16. The threshold according to claim 15, wherein the threshold cap further comprises a second wall extending from an exterior end of the first wall, the second wall extending substantially perpendicularly from the first wall, the second wall configured to be position along an exterior side of the upstanding dam.

17. The threshold according to claim 16, wherein the second wall further comprises at least one resilient seal configured to seal with the exterior side of the dam.

18. The threshold according to claim 11, wherein the threshold cap further comprises a stop arm, and the holder further comprises a catch, wherein the stop arm engages the catch when the threshold cap pivots to an uppermost position of the threshold cap to prevent the threshold cap from pivoting beyond the uppermost position.

19. An assembly for forming a seal with a door panel, the assembly comprising:
a nosing defining an interior side of the assembly when installed;
a holder comprising a knuckle that forms at least a partial barrel about a longitudinal axis; and
a rigid threshold cap configured to underlay the door panel when the door panel is in a closed position, the threshold cap comprising:
a first wall having a top surface and a bottom surface opposite the top surface, the top surface facing a bottom of the door panel in the closed position of the door panel, and
a connection arm extending from the bottom surface towards the nosing, the connection arm terminating in a tip, the tip received in the barrel of the holder such that the threshold cap pivots relative to the holder about the longitudinal axis.
